(19) United States
(12) Patent Application Publication
(10) Pub. No.: US 2025/0192610 A1
(43) Pub. Date: Jun. 12, 2025

(54) CONTROLLER FOR MODULAR POWER SYSTEMS

(71) Applicant: Direct Energy Partners International Corporation, Cornelius, NC (US)

(72) Inventors: Giel Van den Broeck, Aarschot (BE); Dusan Brhlik, Charlotte, NC (US)

(73) Assignee: Direct Energy Partners International Corporation, Cornelius, NC (US)

(21) Appl. No.: 18/844,813

(22) PCT Filed: Aug. 15, 2022
(86) PCT No.: PCT/US2022/040330

§ 371 Date: Sep. 6, 2024

Related U.S. Application Data
(63) Continuation-in-part of application No. PCT/US2022/019163, filed on Mar. 7, 2022.
(60) Provisional application No. 63/156,977, filed on Mar. 5, 2021.

(51) Int. Cl. H02J 13/00; H02J 3/38

(52) U.S. Cl. CPC H02J 13/00006; H02J 3/38; H02J 13/00002; H02J 2203/20

(57) ABSTRACT

Various systems, methods, and computer program products are provided for operating a power system structure via a controller. The method includes receiving a controller run-time code for a power system structure. The controller run-time code is specifically designed to configure and/or operate the power system structure. The method also includes automatically deploying the controller run-time code on the controller. The method further includes commissioning the power system structure using the deployed controller run-time code. The power system structure can be commissioned remotely.

### CROSS-REFERENCE TO RELATED APPLICATION

This patent application is a continuation-in-part of co-pending PCT International Application Number PCT/US22/19163, which claims the benefit of U.S. Provisional Application No. 63/156,977 filed on Mar. 5, 2021, both of which are incorporated herein by reference in their entirety.

### TECHNOLOGICAL FIELD

An example embodiment relates generally to power structure design, and more particularly to generating schematic diagrams for power system structures.

### BACKGROUND

The world's electricity generation and power distribution system is evolving from a centralized model with finite resources where electricity gets generated in one place and distributed to the masses, towards an increasingly more renewable and decentralized operational model, comprising of distributed power electronics, decentralized energy storage systems and decentralized (renewable) electricity generation sources, supplying decentralized loads such as appliances, electric vehicles, lighting, heating, ventilation, cooling individual homes, commercial facilities and communities.

At the same time, this evolution promotes a power system which is becoming increasingly modular, consisting of solar photovoltaic modules, battery modules and power conversion modules to manage power, change voltage and current levels for interoperability, and convert between direct current (DC) and alternating current (AC) for compatibility. Based upon the availability of a variety of modules, system engineers can assemble custom decentralized power systems, featuring generation, storage and distribution assets with intermediate power conversion equipment, as well as protection devices. The modular characteristics of decentralized power systems yields economies-of-scale and reliability-by-redundancy at the same time.

The vast variety of modules available on the market are characterized by limited specifications, lack standardization, have fragmented design tools, process, supply chains and require specialized expertise to engineer and deploy operational systems which meet local regulations. This makes the design process complex, resource intensive, time-consuming, and expensive.

The present invention aims to reduce the complexity of designing distributed, renewable or finite energy generation power systems by partly automating the design process and features.

### BRIEF SUMMARY

The following presents a summary of certain embodiments of the disclosure. This summary is not intended to identify key or critical elements of all embodiments nor delineate the scope of any or all embodiments. Its sole purpose is to present certain concepts and elements of one or more embodiments in a summary form as a prelude to the more detailed description that follows.

In an example embodiment, a system for dynamically generating a power system structure representation is provided. The system includes at least one non-transitory storage device and at least one processing device coupled to the at least one non-transitory storage device. The at least one processing device is configured to provide one or more element icons that is engageable to be added to a power system structure representation. The one or more element icons are each a representative of a physical element that can be used in the power system structure. The at least one processing device is also configured to receive an indication of a first element icon of the one or more element icons to be used in the power system structure. The at least one processing device is further configured to assign the first element icon to one of a plurality of element cells of the power system structure representation. The at least one processing device is still further configured to determine a cell action configured to indicate a relationship between the cell in which the first element icon is assigned and at least one other of the plurality of elements cells of the power system structure.

In some embodiments, the cell action is a connection type between the selected element icon with a second element icon assigned to another cell of the plurality of element cells and the connection type indicates how the physical elements associated with the first element icon and the second element icons are to be connected in the power system structure.

In some embodiments, the at least one processing device is further configured to store an attribute table for each of the one or more element icons with each attribute table including an attribute field and an attribute value. In such an embodiment, the attribute field is a description of the physical element associated with the given element icon and the attribute value is a value relating to said attribute field. In some embodiments, the cell action is determined based on at least one of the attribute table of the first element icon or the attribute table of a second element icon assigned to another cell of the plurality of element cells.

In some embodiments, the at least one processing device is further configured to determine at least one power system structure value indicating the operational efficiency of the power system structure. In some embodiments, the at least one power system structure value includes at least one of a cost to build the power system structure, a cost to operate the power system structure, or a system load of the power system structure.

In some embodiments, each of the physical elements are a load, a generator, a storage device, or a power conversion device. In some embodiments, the power system structure representation is a schematic diagram. In some embodiments, the power system structure representation allows for dynamic changes comprising moving one of the element icons to another cell, wherein the at least one processing device is further configured to update the cell action for the moved element icon.

In some embodiments, the at least one processing device is further configured to provide a selectable icon with information relating to how to purchase a physical element relating to a given element icon.

In another example embodiment, a computer program product for dynamically generating a power system structure representation is provided. The computer program product includes at least one non-transitory computer-readable medium having computer-readable program code portions embodied therein. The computer-readable program code portions include an executable portion configured to provide one or more element icons that is engageable to be added to a power system structure representation. The one or more element icons are each a representative of a physical element that can be used in the power system structure. The computer-readable program code portions also include an executable portion configured to receive an indication of a first element icon of the one or more element icons to be used in the power system structure. The computer-readable program code portions further include an executable portion configured to assign the first element icon to one of a plurality of element cells of the power system structure representation. The computer-readable program code portions still further include an executable portion configured to determine a cell action configured to indicate a relationship between the cell in which the first element icon is assigned and at least one other of the plurality of elements cells of the power system structure.

In some embodiments, the cell action is a connection type between the selected element icon with a second element icon assigned to another cell of the plurality of element cells and the connection type indicates how the physical elements associated with the first element icon and the second element icons are to be connected in the power system structure.

In some embodiments, the computer-readable program code portions include an executable portion configured to store an attribute table for each of the one or more element icons with each attribute table including an attribute field and an attribute value. In such an embodiment, the attribute field is a description of the physical element associated with the given element icon and the attribute value is a value relating to said attribute field. In some embodiments, the cell action is determined based on at least one of the attribute table of the first element icon or the attribute table of a second element icon assigned to another cell of the plurality of element cells.

In some embodiments, the computer-readable program code portions include an executable portion configured to determine at least one power system structure value indicating the operational efficiency of the power system structure. In some embodiments, the at least one power system structure value comprises at least one of a cost to build the power system structure, a cost to operate the power system structure, or a system load of the power system structure.

In some embodiments, teach of the physical elements are a load, a generator, a storage device, or a power conversion device. In some embodiments, the power system structure representation is a schematic diagram.

In some embodiments, the power system structure representation allows for dynamic changes including moving one of the element icons to another cell and the computer-readable program code portions include an executable portion configured to update the cell action for the moved element icon.

In some embodiments, the computer-readable program code portions include an executable portion configured to provide a selectable icon with information relating to how to purchase a physical element relating to a given element icon.

In still another example embodiment, a computer-implemented method for dynamically generating a power system structure representation is provided. The method includes providing one or more element icons that is engageable to be added to a power system structure representation. The one or more element icons are each a representative of a physical element that can be used in the power system structure. The method also includes receiving an indication of a first element icon of the one or more element icons to be used in the power system structure. The method further includes assigning the first element icon to one of a plurality of element cells of the power system structure representation. The method still further includes determining a cell action configured to indicate a relationship between the cell in which the first element icon is assigned and at least one other of the plurality of elements cells of the power system structure.

In some embodiments, the cell action is a connection type between the selected element icon with a second element icon assigned to another cell of the plurality of element cells and the connection type indicates how the physical elements associated with the first element icon and the second element icons are to be connected in the power system structure.

In some embodiments, the method also includes storing an attribute table for each of the one or more element icons with each attribute table comprises an attribute field and an attribute value. In such an embodiment, the attribute field is a description of the physical element associated with the given element icon and the attribute value is a value relating to said attribute field. In some embodiments, the cell action is determined based on at least one of the attribute table of the first element icon or the attribute table of a second element icon assigned to another cell of the plurality of element cells.

In some embodiments, the method also includes determining at least one power system structure value indicating the operational efficiency of the power system structure. In some embodiments, the at least one power system structure value includes at least one of a cost to build the power system structure, a cost to operate the power system structure, or a system load of the power system structure.

In some embodiments, each of the physical elements are a load, a generator, a storage device, or a power conversion device. In some embodiments, the power system structure representation is a schematic diagram.

In some embodiments, the power system structure representation allows for dynamic changes comprising moving one of the element icons to another cell and the method further includes updating the cell action for the moved element icon.

In some embodiments, the method also includes providing a selectable icon with information relating to how to purchase a physical element relating to a given element icon.

In an example embodiment, a controller for operating a power system structure. The controller includes at least one non-transitory storage device and at least one processing device coupled to the at least one non-transitory storage device. The at least one processing device is configured to receive a controller run-time code for a power system structure. The controller run-time code is specifically designed to operate the power system structure. The at least one processing device is also configured to automatically deploy the controller run-time code on the controller. The at least one processing device is further configured to commission the power system structure using the deployed controller run-time code, wherein the power system structure is commissioned remotely.

In various embodiments, the at least one processing device is also configured to receive an update to the controller run-time code based on a change to the power system structure. In various embodiments, the at least one processing device is also configured to generate a configuration of the power system structure with the controller run-time code being configured based on the generated configuration.

In various embodiments, the at least one processing device is also configured to monitor one or more variables for at least one physical element of the power system structure. In various embodiments, the at least one processing device is also configured to monitor one or more variables of the power system structure. In various embodiments, the at least one processing device is also configured to cause a transmission of an alert message based on a change in at least one of the one or more monitored variables of the power system structure. In various embodiments, the one or more monitored variables of the power system structure include at least one of a power consumption or efficiency.

In another example embodiment, a computer program product for operating a power system structure via a controller is provided. The computer program product includes at least one non-transitory computer-readable medium having computer-readable program code portions embodied therein. The computer-readable program code portions include an executable portion configured to receive a controller run-time code for a power system structure. The controller run-time code is specifically designed to operate the power system structure. The computer-readable program code portions also include an executable portion configured to automatically deploy the controller run-time code on the controller. The computer-readable program code portions further include an executable portion configured to commission the power system structure using the deployed controller run-time code. The power system structure is commissioned remotely.

In various embodiments, the computer-readable program code portions further include an executable portion configured to receive an update to the controller run-time code based on a change to the power system structure. In various embodiments, the computer-readable program code portions further include an executable portion configured to generate a configuration of the power system structure with the controller run-time code being configured based on the generated configuration. In various embodiments, the computer-readable program code portions further include an executable portion configured to monitor one or more variable for at least one physical element of the power system structure.

In various embodiments, the computer-readable program code portions further include an executable portion configured to monitor one or more variables of the power system structure. In various embodiments, the computer-readable program code portions further include an executable portion configured to cause a transmission of an alert message based on a change in at least one of the one or more monitored variables of the power system structure. In various embodiments, the one or more monitored variables of the power system structure include at least one of a power consumption or efficiency.

In still another example embodiment, a computer-implemented method for operating a power system structure via a controller is provided. The method includes receiving a controller run-time code for a power system structure. The controller run-time code is specifically designed to operate the power system structure. The method also includes automatically deploying the controller run-time code on the controller. The method further includes commissioning the power system structure using the deployed controller run-time code. The power system structure is commissioned remotely.

In various embodiments, the method also includes receiving an update to the controller run-time code based on a change to the power system structure. In various embodiments, the method also includes monitoring one or more variables for at least one physical element of the power system structure. In various embodiments, the method also includes generating a configuration of the power system structure with the controller run-time code being configured based on the generated configuration.

In various embodiments, the method also includes causing a transmission of an alert message based on a change in at least one of the one or more monitored variables of the power system structure. In various embodiments, the one or more monitored variables of the power system structure include at least one of a power consumption or efficiency.

Embodiments of the present disclosure address the above needs and/or achieve other advantages by providing apparatuses (e.g., a system, computer program product and/or other devices) and methods for dynamically generating a power system structure representation. The system embodiments may comprise one or more memory devices having computer readable program code stored thereon, a communication device, and one or more processing devices operatively coupled to the one or more memory devices, wherein the one or more processing devices are configured to execute the computer readable program code to carry out said embodiments. In computer program product embodiments of the disclosure, the computer program product comprises at least one non-transitory computer readable medium comprising computer readable instructions for carrying out said embodiments. Computer implemented method embodiments of the disclosure may comprise providing a computing system comprising a computer processing device and a non-transitory computer readable medium, where the computer readable medium comprises configured computer program instruction code, such that when said instruction code is operated by said computer processing device, said computer processing device performs certain operations to carry out said embodiments.

### BRIEF DESCRIPTION OF THE DRAWINGS

Having thus described embodiments of the disclosure in general terms, reference will now be made the accompanying drawings, wherein:

FIG. 1 provides a block diagram illustrating a system environment for dynamically generating a power system structure representation, in accordance with embodiments of the present disclosure;

FIG. 2 provides a block diagram illustrating the entity system 200 of FIG. 1, in accordance with embodiments of the present disclosure;

FIG. 3 provides a block diagram illustrating a representation generation engine device 300 of FIG. 1, in accordance with embodiments of the present disclosure;

FIG. 4 provides a block diagram illustrating the computing device system 400 of FIG. 1, in accordance with embodiments of the present disclosure;

FIG. 5 illustrates a flow chart of the method of performing the creation of a schematic diagram of a power system structure in accordance with an embodiment of the present disclosure;

FIG. 6 illustrates a completed example power system structure representation in accordance with embodiments of the present disclosure;

FIG. 7 illustrates a two-dimensional grid representation of a power system structure representation in accordance with embodiments of the present disclosure;

FIGS. 8A-8C illustrate three different element icon configurations in accordance with embodiments of the present disclosure;

FIG. 9 illustrates a generator element icon representing a generator physical element in accordance with embodiments of the present disclosure;

FIG. 10 illustrates a storage element icon representing a storage device physical element in accordance with embodiments of the present disclosure;

FIG. 11 illustrates a load element icon representing a load physical element in accordance with embodiments of the present disclosure;

FIG. 12 illustrates a converter element icon representing a converter physical element in accordance with embodiments of the present disclosure;

FIG. 13 illustrates an element icon and a corresponding attribute table in accordance with embodiments of the present disclosure;

FIGS. 14-16 illustrate example power system structure representation made in accordance with various embodiments of the present disclosure;

FIG. 17 illustrates a flow chart of the method of dynamically generating a power system structure representation in accordance with an embodiment of the present disclosure;

FIG. 18 illustrates an example power system structure that includes an implementation controller device for commissioning and/or operating the power system structure in accordance with an embodiment of the present disclosure;

FIG. 19 illustrates the structure of the run-time code received by the controller in accordance with an embodiment of the present disclosure; and

FIG. 20 illustrates a flow chart of the method of commissioning a power system structure in accordance with an embodiment of the present disclosure.

### DETAILED DESCRIPTION

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described herein, the term “entity” may be any organization that utilizes one or more entity resources, including, but not limited to, one or more entity systems, one or more entity databases, one or more applications, one or more servers, or the like to perform one or more organization activities associated with the entity. In some embodiments, an entity may be any organization that develops, maintains, utilizes, and/or controls one or more applications and/or databases. Applications as described herein may be any software applications configured to perform one or more operations of the entity. Databases as described herein may be any datastores that store data associated with organizational activities associated with the entity. In some embodiments, the entity may be a financial institution which may include herein may include any financial institutions such as commercial banks, thrifts, federal and state savings banks, savings and loan associations, credit unions, investment companies, insurance companies and the like. In some embodiments, the financial institution may allow a customer to establish an account with the financial institution. In some embodiments, the entity may be a non-financial institution.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access and use one or more applications provided by the entity and/or the system of the present disclosure. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, “machine learning algorithms” may refer to programs (math and logic) that are configured to self-adjust and perform better as they are exposed to more data. To this extent, machine learning algorithms are capable of adjusting their own parameters, given feedback on previous performance in making prediction about a dataset. Machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or any suitable form of machine learning algorithm.

As used herein, “machine learning model” may refer to a mathematical model generated by machine learning algorithms based on sample data, known as training data, to make predictions or decisions without being explicitly programmed to do so. The machine learning model represents what was learned by the machine learning algorithm and represents the rules, numbers, and any other algorithm-specific data structures required to for classification.

Embodiments of the present disclosure include a method to organize and automate the design process of decentralized power systems. The method can be embedded in a graphical program, wherein element icons can be drawn on a two-dimensional spatial grid, consisting of individual cells, referenced by coordinates. Element icons are representations of physical elements, such as for example load assets, storage assets, generation assets, power conversion equipment, protection devices, and/or the like. A table of attribute fields and values is attached to each element icon, holding its physical properties. Upon selecting an empty cell of the said spatial grid, the disclosed method will suggest a new entity to add to the selected empty cell of the spatial grid. Upon selecting a non-empty cell of the said spatial grid, the disclosed method will suggest attribute values in the attribute fields attached to the selected non-empty cell. Attribute fields are grouped in independent data layers, enabling replicability and combinations of data layers. Multiple two-dimensional spatial grids can be linked by means of referencing element icon, enabling to create instances of existing designs and maximize replicability.

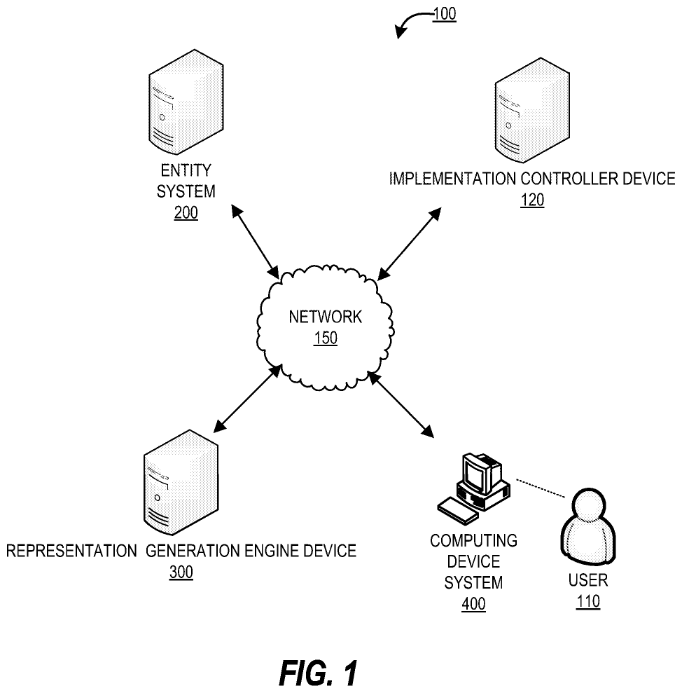

FIG. 1 provides a block diagram illustrating a system environment 100 for dynamically generating a power system structure representation. As illustrated in FIG. 1, the environment 100 includes a representation generation engine device 300, an entity system 200, an implementation controller device 120, and a computing device system 400. One or more users 110 may be included in the system environment 100, where the users 110 interact with the other entities of the system environment 100 via a user interface of the computing device system 400. In some embodiments, the one or more user(s) 110 of the system environment 100 may be employees (e.g., application developers, database administrators, application owners, application end users, business analysts, finance agents, or the like) of an entity associated with the entity system 200.

The entity system(s) 200 may be any system owned or otherwise controlled by an entity to support or perform one or more process steps described herein. In some embodiments, the entity is a financial institution. In some embodiments, the entity may be a non-financial institution. In some embodiments, the entity may be any organization that utilizes one or more entity resources to perform one or more organizational activities.

The representation generation engine device 300 is a system of the present disclosure for performing one or more process steps described herein. In some embodiments, the representation generation engine device 300 may be an independent system. In some embodiments, the representation generation engine device 300 may be a part of the entity system 200. For example, the methods discussed herein may be carried out by the entity system 200, the representation generation engine device 300, the computing device system 400, and/or a combination thereof.

The representation generation engine device 300, the implementation controller device 120, the entity system 200, and/or the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the representation generation engine device 300 is configured to communicate information or instructions with the entity system 200, and/or the computing device system 400 across the network 150. While the entity system 200, the representation generation engine device 300, the computing device system 400, and implementation controller device 120 are illustrated as separate components communicating via network 150, one or more of the components discussed here may be carried out via the same system (e.g., a single system may include the entity system 200 and the representation generation engine device 300).

The computing device system 400 may be a system owned or controlled by the entity of the entity system 200 and/or the user 110. As such, the computing device system 400 may be a computing device of the user 110. In general, the computing device system 400 communicates with the user 110 via a user interface of the computing device system 400, and in turn is configured to communicate information or instructions with the representation generation engine device 300, and/or entity system 200 across the network 150.

The implementation controller device 120 may be a system owned or controlled by the entity of the entity system 200. The implementation controller is configured to commission a physical power system structure based on the power system structure representation. The implementation controller device 120 may receive information relating to one or more element icons in a power system structure representation (e.g., attribute values from the attribute table corresponding to the given element icons). The implementation controller device 120 may be configured to autogenerate code for the physical elements associated with the element icons in the power system structure representation. Based on known information relating to the physical elements, the implementation controller device 120 can generate code for operating functionality of the physical power system structure (when constructed). As discussed below, the system may be configured to generate the operating code for the power system structure and, in some instances, allow for a user to download the operating code for use with the power system structure once constructed. As such, the implementation time for a power system structure is reduced as no programming is required to commission a power system structure.

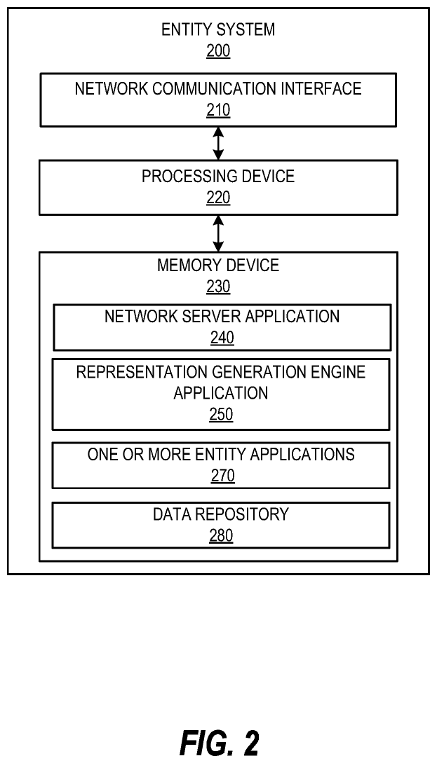

FIG. 2 provides a block diagram illustrating the entity system 200, in greater detail, in accordance with embodiments of the disclosure. As illustrated in FIG. 2, in one embodiment, the entity system 200 includes one or more processing devices 220 operatively coupled to a network communication interface 210 and a memory device 230. In certain embodiments, the entity system 200 is operated by a first entity, such as a financial institution. In some embodiments, the entity system 200 may be a multi-tenant cluster storage system.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a representation generation engine application 250, one or more entity applications 270, and a data repository 280 comprising data accessed, retrieved, and/or computed by the entity system 200. The one or more entity applications 270 may be any applications developed, supported, maintained, utilized, and/or controlled by the entity. The computer-executable program code of the network server application 240, the representation generation engine application 250, the one or more entity application 270 to perform certain logic, data-extraction, and data-storing functions of the entity system 200 described herein, as well as communication functions of the entity system 200.

The network server application 240, the representation generation engine application 250, and the one or more entity applications 270 are configured to store data in the data repository 280 or to use the data stored in the data repository 280 when communicating through the network communication interface 210 with the representation generation engine device 300, and/or the computing device system 400 to perform one or more process steps described herein. In some embodiments, the entity system 200 may receive instructions from the representation generation engine device 300 via the representation generation engine application 250 to perform certain operations. The representation generation engine application 250 may be provided by the representation generation engine device 300. The one or more entity applications 270 may be any of the applications used, created, modified, facilitated, and/or managed by the entity system 200. The representation generation engine application 250 may be in communication with the representation generation engine device 300. In some embodiments, portions of the methods discussed herein may be carried out by the entity system 200.

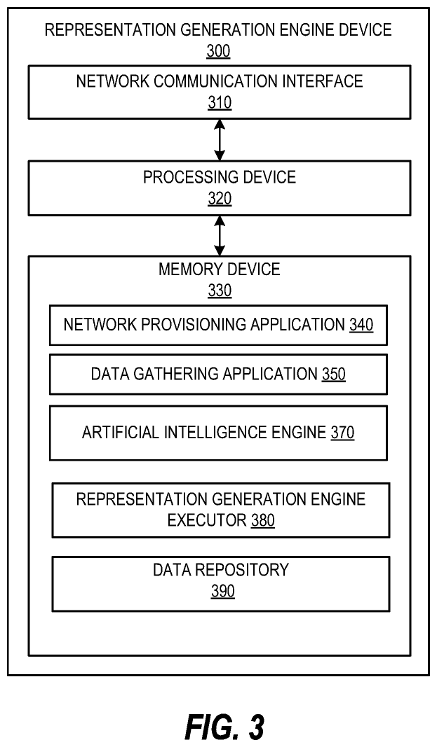

FIG. 3 provides a block diagram illustrating the representation generation engine device 300 in greater detail, in accordance with various embodiments. As illustrated in FIG. 3, in one embodiment, the representation generation engine device 300 includes one or more processing devices 320 operatively coupled to a network communication interface 310 and a memory device 330. In certain embodiments, the representation generation engine device 300 is operated by an entity. In some embodiments, the representation generation engine device 300 is owned or operated by the entity of the entity system 200. In some embodiments, the representation generation engine device 300 may be an independent system. In alternate embodiments, the representation generation engine device 300 may be a part of the entity system 200. The representation generation engine device 300 may be configured to generate the power system structure representations discussed here. Namely, the representation generation engine device 300 may be configured to determine the interconnections between individual element icons (e.g., how the element icons interact, which icons are producing, using, and/or storing the power within a system).

It should be understood that the memory device 330 may include one or more databases or other data structures/repositories. The memory device 330 also includes computer-executable program code that instructs the processing device 320 to operate the network communication interface 310 to perform certain communication functions of the representation generation engine device 300 described herein. For example, in one embodiment of the representation generation engine device 300, the memory device 330 includes, but is not limited to, a network provisioning application 340, a data gathering application 350, an artificial intelligence engine 370, a representation generation engine executor 380, and a data repository 390 comprising any data processed or accessed by one or more applications in the memory device 330. The computer-executable program code of the network provisioning application 340, the data gathering application 350, the artificial intelligence engine 370, and the representation generation engine executor 380 may instruct the processing device 320 to perform certain logic, data-processing, and data-storing functions of the representation generation engine device 300 described herein, as well as communication functions of the representation generation engine device 300.

The network provisioning application 340, the data gathering application 350, the artificial intelligence engine 370, and the representation generation engine executor 380 are configured to invoke or use the data in the data repository 390 when communicating through the network communication interface 310 with the entity system 200, and/or the computing device system 400. In some embodiments, the network provisioning application 340, the data gathering application 350, the artificial intelligence engine 370, and the representation generation engine executor 380 may store the data extracted or received from the entity system 200, and the computing device system 400 in the data repository 390. In some embodiments, the network provisioning application 340, the data gathering application 350, the artificial intelligence engine 370, and the representation generation engine executor 380 may be a part of a single application.

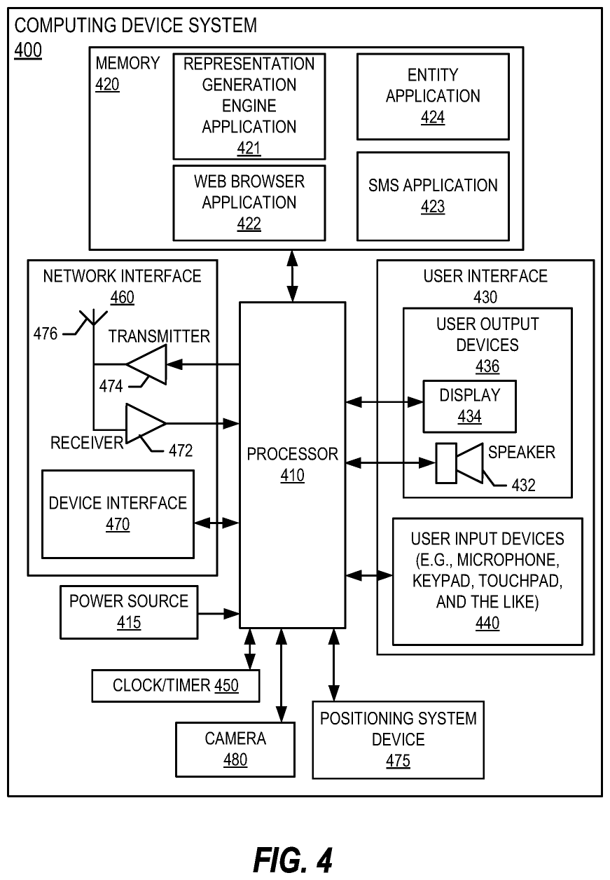

FIG. 4 provides a block diagram illustrating a computing device system 400 of FIG. 1 in more detail, in accordance with various embodiments. However, it should be understood that a mobile telephone is merely illustrative of one type of computing device system 400 that may benefit from, employ, or otherwise be involved with embodiments of the present disclosure and, therefore, should not be taken to limit the scope of embodiments of the present disclosure. Other types of computing devices may include portable digital assistants (PDAs), pagers, mobile televisions, electronic media devices, desktop computers, workstations, laptop computers, cameras, video recorders, audio/video player, radio, GPS devices, wearable devices, Internet-of-things devices, augmented reality devices, virtual reality devices, automated teller machine (ATM) devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 150. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include one or more displays 430 (e.g., a liquid crystal display or the like) and a speaker 432 or other audio device, which are operatively coupled to the processor 410. The user interface may be used to render the power system structure representations as discussed herein.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a representation generation engine application 421, entity application 424. These applications also typically instructions to a graphical user interface (GUI) on the display 430 that allows the user 110 to interact with the entity system 200, the representation generation engine device 300, and/or other devices or systems. The memory 420 of the computing device system 400 may comprise a Short Message Service (SMS) application 423 configured to send, receive, and store data, information, communications, alerts, and the like via the wireless network 150. In some embodiments, the representation generation engine application 421 provided by the representation generation engine device 300 allows the user 110 to access the representation generation engine device 300. In some embodiments, the entity application 424 provided by the entity system 200 and the representation generation engine application 421 allow the user 110 to access the functionalities provided by the representation generation engine device 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

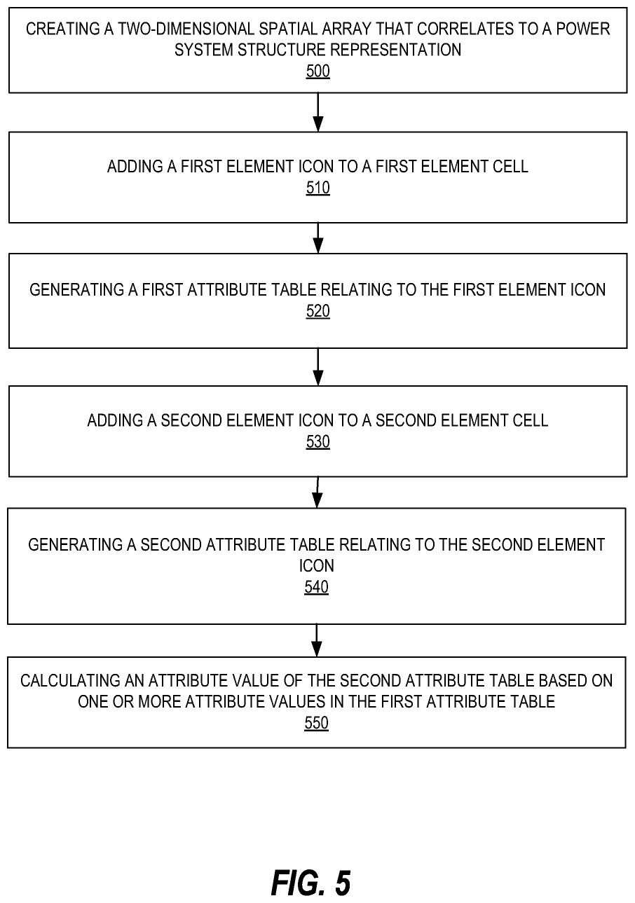

Referring now to FIG. 5, a method according to an example embodiment to perform the creation of a schematic diagram of a power system structure (e.g., a decentralized power system structure) is provided. The power system structure can include load, generation, storage devices, power conversion elements, and/or other components of a power system structure. The creation of schematic diagrams is a time-consuming and labor-intensive task and by means of the presented method, the present disclosure accelerates and organizes the process of creating a schematic diagram. The method can be embodied into a computer program, executed by a desktop computer or mobile device (e.g., a computing device 400).

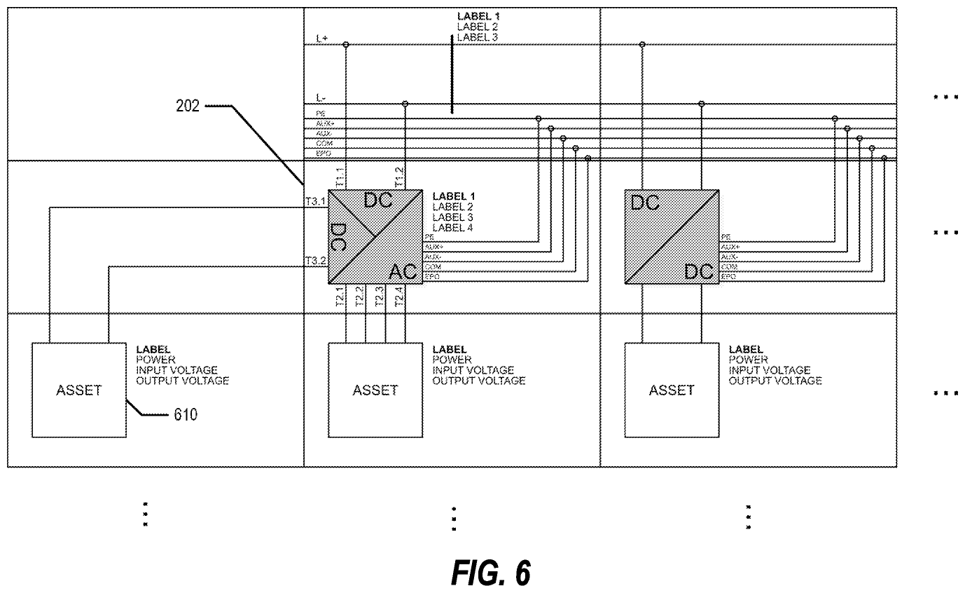

FIG. 6 illustrates a completed example power system structure representation. A shown, there are a plurality of element cells (e.g., nine cells are shown with cell 202 in the middle). Each element cell may have an element icon (e.g., asset 610) assigned therein. Each element icon corresponds to a physical element that can be used in a power system structure. The elements are then connected to other element icons in other element cells with visual representations of the connections of the physical elements corresponding to the given element icons.

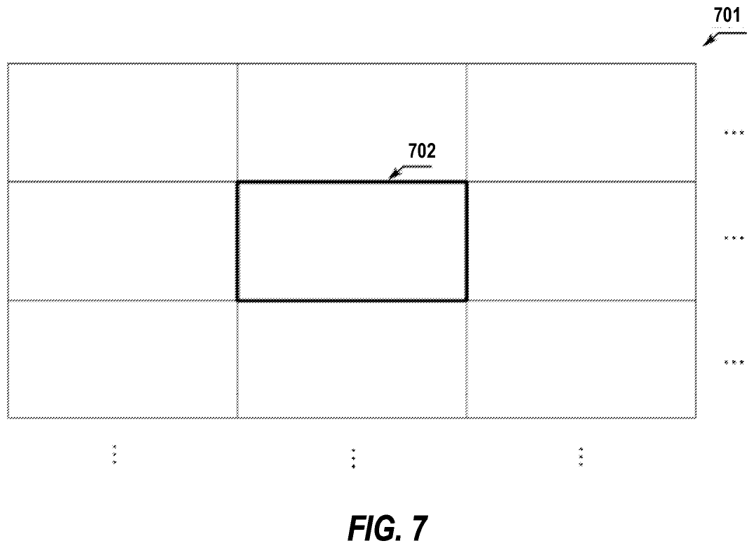

Referring now to Block 500 of FIG. 5, the method may include creating a two-dimensional spatial array that correlates to a power system structure representation. As shown in FIG. 7, the spatial array may be configured as a grid 201. The grid may be a two-dimensional spatial array of rows and columns of element cells. The spatial array may be rendered on the user interface of a user device (e.g., computing device 400). Each element cell is a unique location on the grid and can be identified and referenced by said cell's row and column number, featuring a left, right, top and bottom boundary. For example, element cell 702 is in row two, column two of the power system structure representation. The number of rows and the number of columns of the power system structure representation exceed one and may be unbound. The grid 701 of the power system structure representation may be used in various embodiments discussed herein.

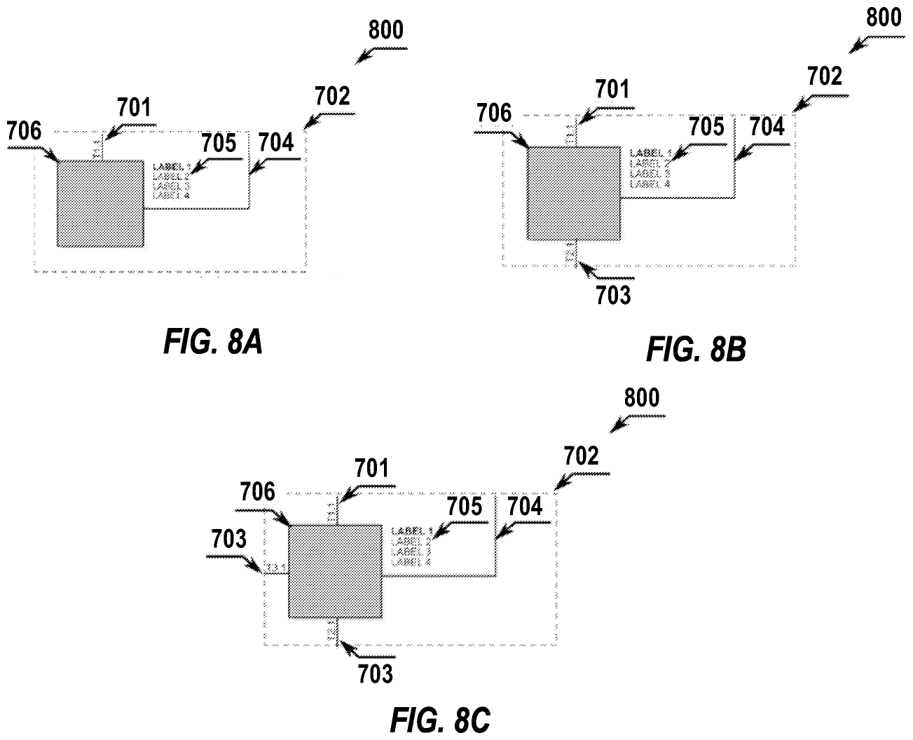

Referring now to Block 510 of FIG. 5, the method may include adding a first element icon to a first element cell. As shown in FIGS. 8A-8C, a first element icon 800 can be assigned to a given element cell 702. Referring to FIG. 8A, a first element icon 800 is a schematic representation of a physical element (e.g., an asset or a link in a schematic diagram). The physical element may be a load, generator, storage device, a power conversion apparatus, a link representing an electrical connection, and/or the like. The schematic representation of an element icon is confined within the boundaries of an element cell 702. Each element cell (e.g., element cell 702) may each contain a maximum of one element icon. The element icon 800 can include a label 705, a symbol 706 and a first port at the top, wherein the first port comprises a terminal 701. Optionally, an element icon can include an auxiliary terminal 704. As shown in FIG. 8B, an element icon 800 may also include a second port at the bottom, comprising a terminal 703. Referencing FIG. 3 (c), embodiments of an entity optionally comprise a third port on the left, the third port comprising a terminal 703. Each of the terminal 701, auxiliary terminal 704, and terminal 703 may connect the element icon to another element icon in another element cell.

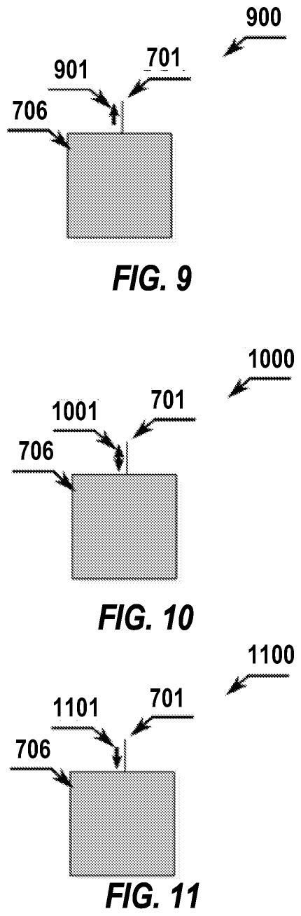

The element icon may be one of a plurality of subclasses. For example, the element icon may be one of four subclasses. An example element icon subclasses may be a generator element icon 900 (e.g., corresponding to a generator physical element), as shown in FIG. 9. As shown, the terminal 701 has an upward indication of current flow direction 901 out of the symbol 706, which indicates that the generator element icon 900 produces power for a power system structure (e.g., the current flows out of the generator element icon 900).

Another example element icon subclass may be a storage element icon 1000 (corresponding to a storage device physical element) as shown in FIG. 10. As shown, the terminal 701 has a bidirectional current flow direction 1001 from the symbol 706 indicating that current can flow both to and from the storage element icon 1000 (e.g., the storage device physical element stores and transmits power).

Another example element icon subclass may be a load element icon 1100 (corresponding to a load physical element) as shown in FIG. 11. As shown, the terminal 701 has a current flow direction 1101 into the symbol 706 indicating that current can flows into the load element icon 1100 (e.g., the load physical element consumes power).

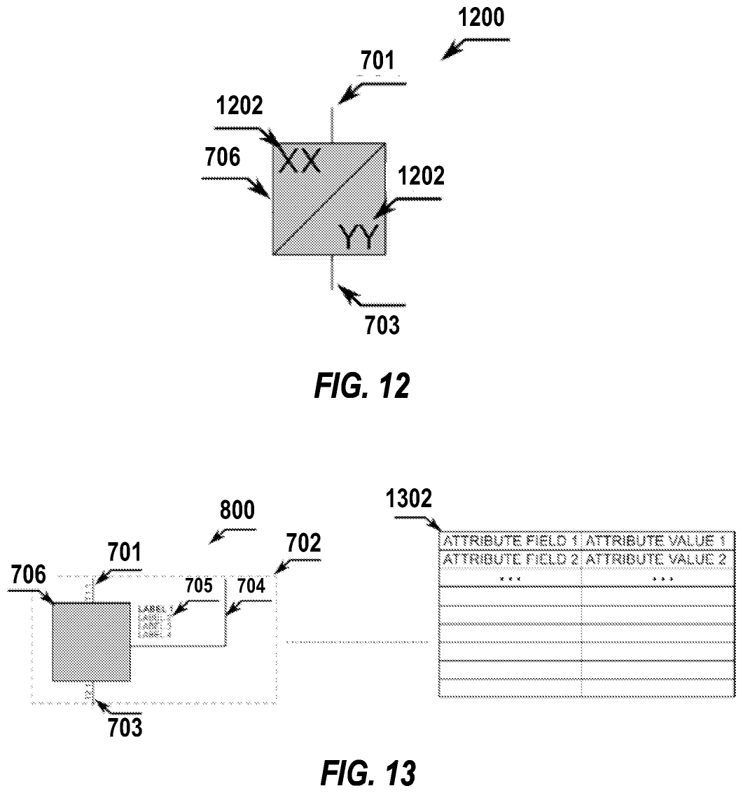

Still another example element icon subclass may be a converter element icon 1200 (corresponding to a converter physical element) as shown in FIG. 12. The converter element icon 1200 may include terminal 701 and terminal 703. As such, the converter may converter AC current into DC current. For example, the AC current may be received by converter via the terminal 701 and then converted to DC current and output via terminal 703 to the power system structure. The element icons shown herein are merely illustrative and may include different configurations based on design.

Referring now to Block 520 of FIG. 5, the method includes generating a first attribute table relating to the first element icon. As shown in FIG. 13, the attribute table 1301 is associated with the first element icon 800. The first attribute table 1302 can be stored within a storage medium (e.g., entity device 200 and/or other components). The attribute table is a table with attribute fields and associated attribute values. An attribute field is a description of a physical property of the physical element associated with the first element icon. The attribute value is a value of the said attribute field. Examples of attribute fields include number of connections, nominal voltage, nominal current, nominal power, and/or the like. Each element icon may have an attribute table.

Referring now to Block 530 of FIG. 5, the method also includes adding a second element icon to a second element cell. The addition of the second element icon to the second element cell may be the same or similar to the addition of the first element icon to the first element cell. Additionally, referring now to Block 540 of FIG. 5, the method may also include generating a second attribute table relating to the second element icon. As discussed herein, the second attribute table may be generated in a similar fashion to the first attribute table.

In some embodiments, one or more attribute values for a second attribute table may be based on one or more attribute values in the first attribute table. Referring now to Block 550 of FIG. 5, the method includes calculating an attribute value of the second attribute table based on one or more attribute values in the first attribute table. An attribute value of the second attribute table may be calculated, as a function of an attribute value of the first attribute table. For example, an attribute value of the second attribute table ay be a function of the number of connections of the first or second port of the second element icon compared to the number of connections of the first or second port of the first element icon, the line color of the terminals of each element icon, a comparison of the attribute values of the second attribute table to the attribute values of the first attribute table, and/or the like. The attribute value calculation may also based on a comparison of manufacturer between the physical element associated with the first element icon and the physical element associated with the second element icon.

In some instance, a layer attribute may be included in the attribute table for each element icon. For example, an attribute field of a given attribute table may include one out of three attribute values that correspond to a given layer (e.g., 0 (asset layer), 1 (converter layer), 2 (switchgear layer)). In Block 510 of FIG. 5, in which the first entity is drawn, the element icon 800 may only be drawn if the attribute value of the first attribute field is larger or equal to the attribute value of the second attribute field. Additionally in Block 530 of FIG. 5, in which the second entity is drawn, the second entity may only be drawn if the attribute value of the first attribute field is larger or equal to the attribute value of the third attribute field.

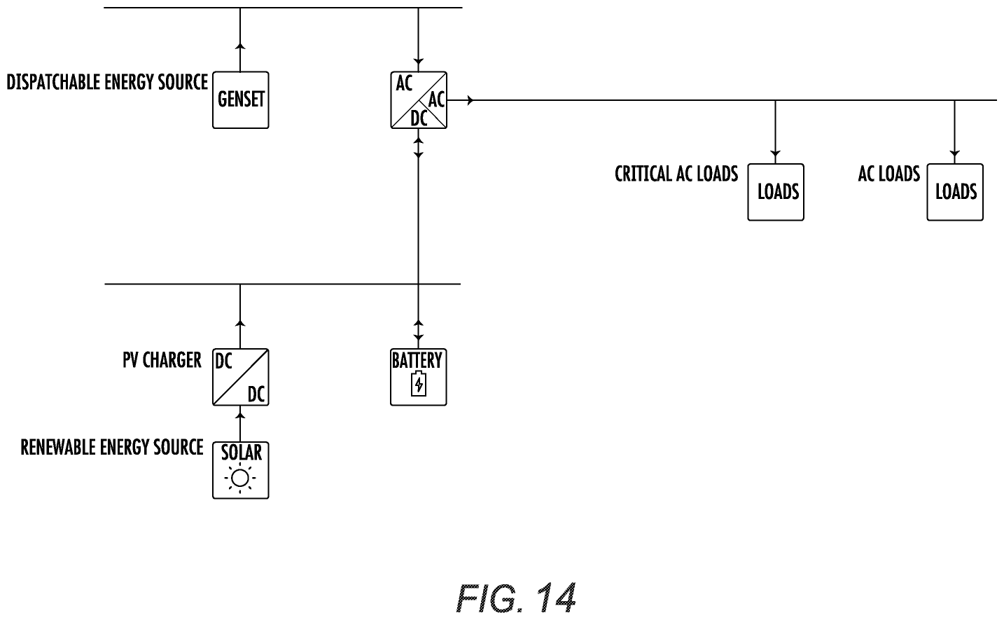

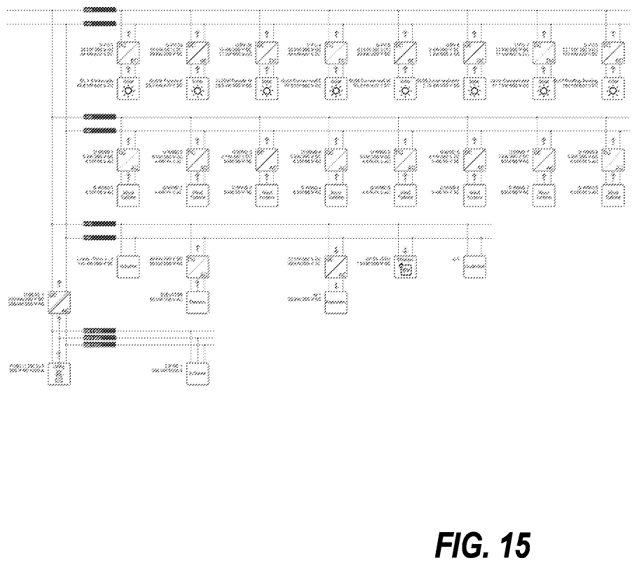

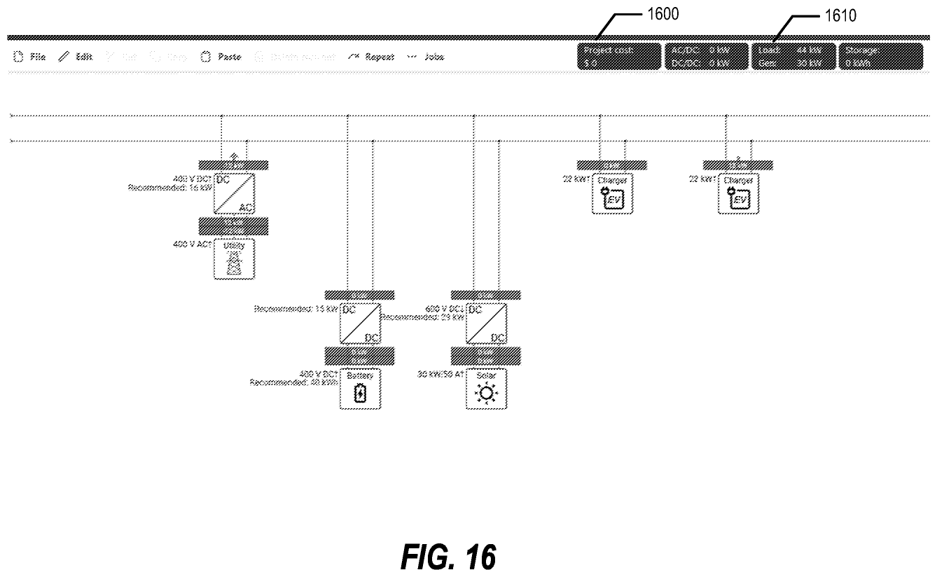

FIG. 14-16 are various example power system structure representations that may be generated using various embodiments of the present disclosure. As shown the element icons can be connected to one another, with indication of the flow of current. FIG. 14 illustrates a basic diagram, while FIG. 15 illustrates a more complex diagram that includes element icon information, such as load, capacity, and/or the like. FIG. 16 also provides recommendations for element characteristics, as well as projected cost 1600, load and generated power values 1610.

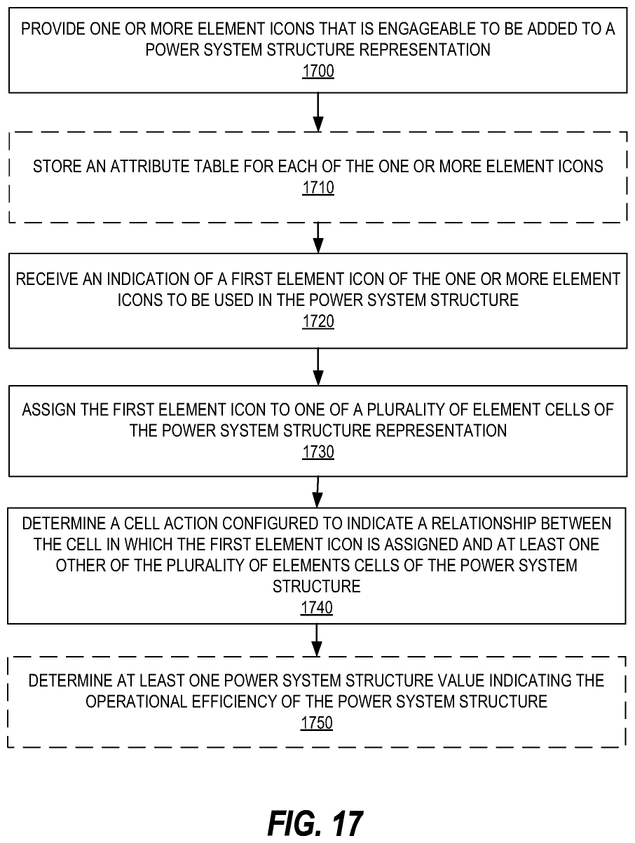

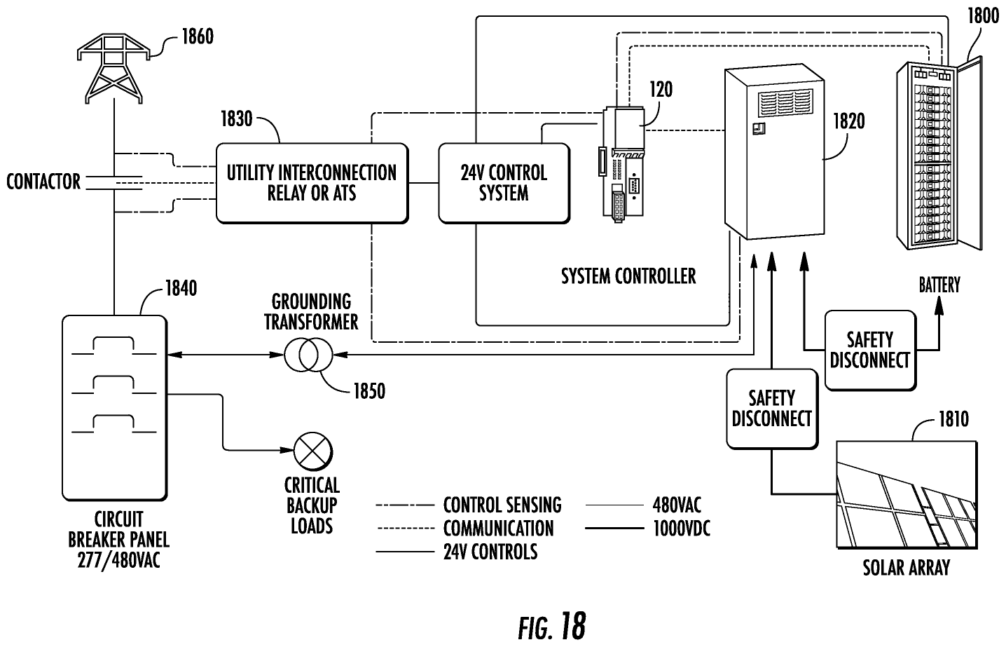

FIG. 17 illustrates an example method of dynamically generating a power system structure representation. The power system structure representation may be a schematic. The power system structure may be a digital representation of a potential power system structure. As such, the power system structure representation can be used to plan and build a power system structure. The method of FIG. 17 may include processes similar to or the same as the method of FIG. 6 discussed above, unless otherwise noted. The method may be carried out by a system discussed herein (e.g., the entity system 200, the representation generation engine device 300, the implementation controller device 120, and/or the computing device system 400). An example system may include at least one non-transitory storage device and at least one processing device coupled to the at least one non-transitory storage device. In such an embodiment, the at least one processing device is configured to carry out the method discussed herein.

Referring now to Block 1700 of FIG. 17, the method includes providing one or more element icons that is engageable to be added to a power system structure representation. The method includes causing a rendering of a user interface (e.g., provided to a computing device system 400 associated with a user 110). The user interface includes one or more element icons that are selectable by a user device. Each of the one or more element icons are representative of a physical element that can be used in the power system structure. Therefore, there may be multiple element icons selectable by the user device. The physical elements can include, for example, a load, a generator, a storage device, and/or a power conversion device. The element icons can include information about a given physical element, such as element name, power amount, and/or the like.

Referring now to optional Block 1710 of FIG. 17, the method includes storing an attribute table for each of the one or more element icons. Each element icon may have an attribute table that includes information relating to said physical element represented by the element icon. An attribute table may include an attribute field and an attribute value (as discussed in reference to FIG. 13 discussed above). The attribute field is a description of the physical element, such as element name, part number, and/or other identifiers. The attribute value includes information relating to the performance of the physical element, such as power capacity, power load, installation cost, operating cost, and/or the like. Each physical element may have a plurality of attribute values.

The attribute tables may be generated manually (e.g., an operator may manually input values into the attribute tables. The attribute table may be generated by a third party. For example, a vendor or manufacturer for a given physical element may provide the information used in the attribute table. In some instances, the system may generate an attribute table based on said information provided by the third party. In some instances, the third party vendor may provide the attribute table (e.g., the third party vendor may generate an attribute table specifically for the system herein). Additionally or alternatively, the attribute tables may be generated automatically. The attribute values for an attribute table may be determined based on information relating to the physical element. For example, the system may be configured to generate an attribute table based on the technical specification of a given physical element.

Referring now to Block 1720 of FIG. 17, the method includes receiving an indication of a first element icon of the one or more element icons to be used in the power system structure. The system may receive an input from the user via the computing device 400 to user a given element icon in a power system structure representation. The input by the user may be a click and/or drag of the element icon. For example, the user may drag the element icon from the portion of the screen containing the one or more element icons into the portion of the user interface containing the power system structure representation. In some instances, the indication may include the intended position of the first element icon within the power system structure representation (e.g., a user may drag the first element icon to a specific place on the power system structure representation). In some instances, the system may be configured to automatically place the selected first element icon into the power system structure representation based on the positioning of one or more other icon elements on the power system structure representation.

Referring now to Block 1730 of FIG. 17, the method includes assigning the first element icon to one of a plurality of element cells of the power system structure representation. Based on the indication of the first element icon, the system is configured to assign the first element icon to one of the element cells of the power system structure representation. Each element cell may contain only a singular element icon. As discussed above, the indication of the first element icon may include a positioning of the first element icon within the power system structure representation. Subsequent selected element icons can be assigned to cells in the same way discussed for the first element icon. The power system structure representation allows for dynamic changes via the user interface. For example, the user may move one of the element icons from one element cell to another element cell. As will be discussed below in more detail in reference to Block 1740, the system is configured to update the cell action for the moved element icon.

Referring now to Block 1740 of FIG. 17, the method includes determining a cell action configured to indicate a relationship between the cell in which the first element icon is assigned and at least one other of the plurality of elements cells of the power system structure. The cell action determines the interactions between different cells within the power system structure representation. For example, the cell action for a first selected icon is a connection type between the selected first element icon with a second element icon assigned to another cell of the plurality of element cells and the connection type indicates how the physical elements associated with the first element icon and the second element icons are to be connected to one another in the power system structure.

Examples of the connections between the cells are shown and discussed in reference to FIGS. 8A through 13 discussed above. The cell actions are determined based on at least one of the attribute table of the first element icon or the attribute table of a second element icon assigned to another cell of the plurality of element cells. The attribute table may include compatibility information for a physical element and the compatibility information may be used to determine how and/or if two physical elements can successfully operate in a power system structure. For example, a load may require a specific amount of power to operate and therefore the system determines whether a power source (e.g., a battery) should be connected to the load in order to operate the load.

Referring now to Block 1750 of FIG. 17, the method includes determining at least one power system structure value indicating the operational efficiency of the power system structure. The system can also be configured to determine information about the power system structure. The power system structure value can include a cost to build the power system structure, a cost to operate the power system structure, or a system load of the power system structure. The power system structure value may be an estimate of a performance indicator of a power system structure in a power system structure representation. The power system structure value may be rendered on the user interface. The power system structure value may be based on one or more attribute values in the attribute table relating to the physical elements in the power system structure. For example, each attribute table may include installation cost, operating cost, operating load, and/or other various characteristics that may be used to determine system wide performance indicators.

Additionally, the method may include providing one or more additional platform tools that assist the building of a power system structure represented by the power system structure representation. The platform tools may connect a user to one or more vendors for the physical elements in the power system structure representation. The user interface may have a selectable icon with information relating to how to purchase a physical element relating to a given element icon. Additionally, the user interface may provide cost estimates based on real-time or near real-time pricing (e.g., price provided by a vendor may be displayed on the user interface and/or used by the system to determine the cost estimate for the power system structure). The platform may be configured to facilitate the purchase of one or more elements from said vendor(s) within the platform. Additionally or alternatively, the system may provide a user with vendor information for the user to then contact the vendor to purchase said element.

The platform tools may also include providing information for one or more contractors that are capable of constructing at least a portion of the power system structure. For example, the system may store one or more contractors that are capable of performing one or more necessary installation. The system may be configured to recommend one or more contactors based on various user characteristics, such as location. For example, the system may recommend a contactor that services the area in which the user plans to build the power system structure. The system may determine which contractor(s) to recommend using various considerations, such as contractor rating, job type, contractor availability, and/or the like. The recommendation of one or more contractors may be provided to a user on the user interface. In some instances, the contractor recommendation may include contact information that will allow the user to contact the contractor. In some embodiments, the system may also be configured to facilitate communication between contractors and users (e.g., consumers). For example, a contractor may have an account in which the contractor can communicate with a potential customer.

In some embodiments, the system may also be configured to autogenerate an operating code for the power system structure based on the power system structure representation. For example, the implementation controller device 120 may be configured to produce operating code that can be used to commission a physical power system structure based on the power system structure representation. The implementation controller device 120 may receive information relating to one or more element icons in a power system structure representation (e.g., attribute values from the attribute table corresponding to the given element icons). Since the power system structure representation includes element icons associated with physical elements, the attribute values of the physical elements can be used to produce the necessary operating code.

For example, batteries from different manufacturers may have slightly different operations and subsequently require different operating code to account for any changes. Since the element icons relate to a specific physical element, the attribute table relating to the element icon may include information that can be used for generating operating code for the physical elements of a power system structure. Using the attribute table for each element icon in a power system structure representation, the implement device controller 120 can generate the operating code required to commission a power system structure (e.g., the operating code is sufficient for causing the physical element of the power system structure to operate as intended).

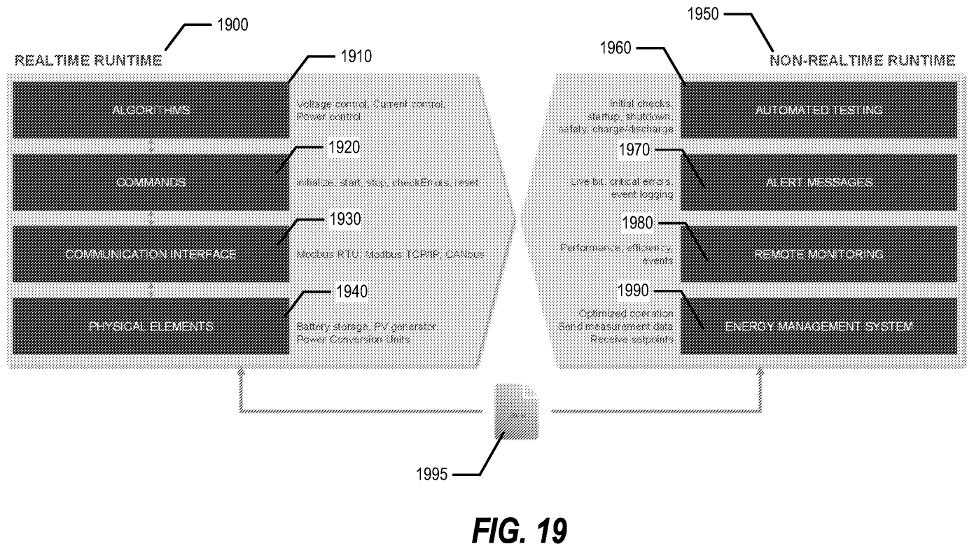

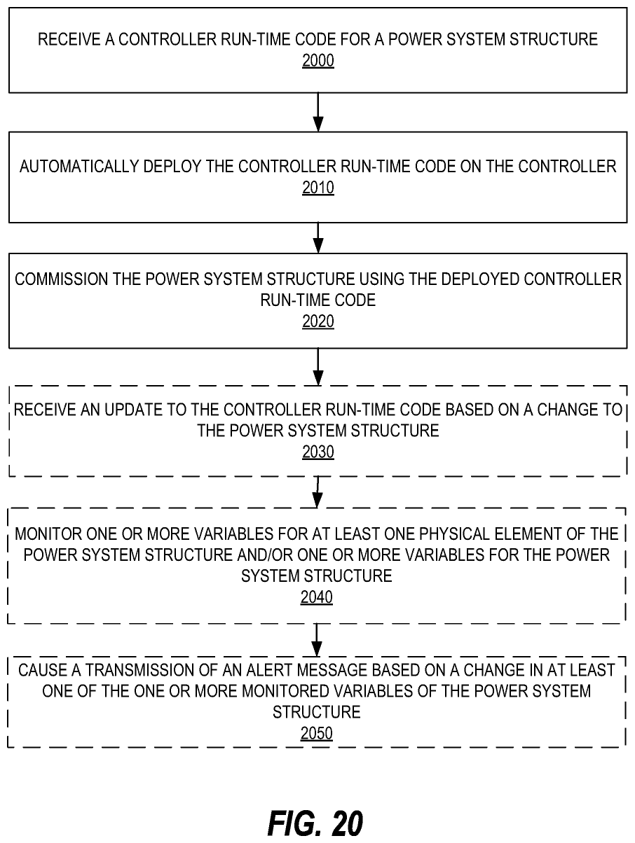

The autogenerated operating code can be made downloadable by the user for use with the power system structure once constructed. For example, the user interface may have a selectable icon that allows for the user to download the operating code for the controller (e.g., an icon may read “Download for Controller”). Additionally, an implementation controller device 120 may be installed directly into a power system structure. For example, the implementation controller device 120 may be in communication with the power system structure and provide the operating code therein. In some instances, a user may download the operating code from the system to another controller device that is used in the power system structure. As such, the implementation time for a power system structure is reduced as no programming is required to commission a power system structure. The operating code may also be referred to as “controller run-time code” or “run-time code” as discussed below in reference to FIGS. 19 and 20.

Additionally, the system may allow for remote testing and commissioning of power system structures upon completion. For example, the implementation controller device 120 may be configured to automate test on the power system structures upon installation. The results of the automated tests may be compared to the estimated power system structure values determined by the system. Additionally, a report based on the test can be automated and provided to support engineers to allow them to adjust or change the power system structure to reach desired performance.

FIG. 18 illustrates an example power system structure that includes an implementation controller device for commissioning and/or operating the power system structure in accordance with an embodiment of the present disclosure. As shown, the implementation controller device 120 (“controller 120”) may be connected to the one or more physical elements, such as an energy storage device (e.g., battery 1800), a solar array 1810, a power conversion system 1820, a relay 1830, a circuit breaker panel 1840, a grounding transformer 1850, and a utility grid 1860. The controller 120 is configured to control the operations of each physical element (e.g., managing the interactions between the solar array 1810/battery 1800 with the rest of the utility grid 1860. The controller 120 may be configured to be remotely deployed and commissioned using the various operations discussed herein.

The power system structure shown in FIG. 18 is merely an example power system structure that can use a controller as discussed herein. Various power system structures may include different physical elements, such as a load, a generator, a storage device, and/or a power conversion device. Additionally, physical elements can differ across different brands or models, such that each component can cause the controller 120 to be updated to operate effectively. During the initial commissioning, power system structures with traditional controllers must be manually commissioned by on-site programmers, which costs both time and money, as a system can take weeks to be commissioned. However, the controller 120 of various embodiments allow for remote commissioning, as the controller run-time code is pre-generated (e.g., by the methods discussed herein). Additionally, the controller 120 allows for real-time tracking and power management, that can be used to improve the efficiency of the power system structure.

FIG. 19 illustrates the structure of the run-time code received by the controller in accordance with an embodiment of the present disclosure. As shown, the run-time code may include information relating to real-time run-time operations 1900 and non-real-time run-time operations 1950. The real-time run-time operation 1900 can include code and/or information relating to algorithms 1910, commands 1920, communicating with a communication interface 1930, and the physical elements of the power system structure 1940.

The algorithms 1910 may be used to determine various power system structure expected variables, such as the intended/recommended voltage control, the intended/recommended current control, and/or the intended/recommended power control. The algorithms may use machine learning to determine the intended/recommended voltage control, the intended/recommended current control, and/or the intended/recommended power control. The commands 1920 may include the necessary code to perform initialization of the power system structure, stopping and/or starting the power system structure, resetting the power system structure, and/or checking the power system structure for errors.

The communication interface information 1930 may contain information and/or code to communicate with a communication interface. The communication interface information 1930 may use various communication protocols, such as Modbus RTU, Modbus TCP/IP, and/or CANbus. The communication interface information allows for the controller 120 to communicate to various communication interfaces.

The real-time run-time operations relating to the physical elements 1940 may include information and/or code relating to specific physical elements of the given power system structure. The physical elements can include, for example, energy storage devices, power generators, and/or power conversion devices. The run-time code may be specifically altered based on the specific physical elements of the power system structure.

The run-time code may also include real-time run-time operations 1950. The real-time run-time operations 1950 can include information and/or code relating to automated testing 1960, transmitting alert messages 1970, remote monitoring 1980, and/or energy management 1990. The automated testing may include standards and/or scheduled tests. The automated tests may include initial tests that are completed during and/or after commissioning, startup and/or shutdown testing, safety testing, and/or charge/discharge testing.

The information relating to the transmission of alert messages 1970 may include sending live bit information on system operation, critical error information, and/or event logs to one or more users upon determination of an issue. The alert messages may come as a result of the automated testing 1960 and/or remote monitoring 1980. The remote monitoring information 1980 includes instructions for monitoring the power system structure, such as monitoring for performance, efficiency, and/or specific events (e.g., a malfunction). The remote monitoring information 1980 may be used in connection with the energy management system 1990. The energy management system 1990 may include optimized operation variables. The energy management system 1990 may also be configured to send measurement data relating to the power system structure and/or receive operating variables for the power system structure. The run-time code may be stored in one or more files 1995. The run-time code may be stored as a JSON file. The JSON file may then be transmitted to the controller 120 for use as discussed in reference to FIG. 20 below.

The run-time code may include multiple files (e.g., multiple JSON files or the like). For example, the run-time code may include one or more device configuration files (e.g., a device JSON file) that lists all physical elements present in a power system structure. Such a device configuration file may include references to other files, such as a control configuration file and/or an address map file.

The run-time code may also include one or more control configuration files (e.g., a control JSON file) that includes specific commands linked to a sequence of communication registers and values to be sent within the power system structure. The specific commands are based on the specific physical elements of the power system structure. Each individual physical element may have an individual control configuration file (e.g., each different type of physical element in the power system structure may have a control configuration file with specific commands for the given physical element).

The run-time code may also include one or more address map files that contains specific communication registers for the physical elements. Each physical element may have an individual address map file. The run-time code may include various other files that are used to commission and/or operate the power system structure. The run-time code is configured based on the specific power system structure (e.g., upon configuring the power system structure as discussed herein, the run-time code may be generated based on the physical elements of the power system structure).

FIG. 20 illustrates a flow chart of the method of commissioning and/or operating a power system structure. The power system structure may be the physical implementation of a digital representation generated by the operations of FIG. 17. The method may be carried out by the controller 120 discussed herein. An example controller 120 may include at least one non-transitory storage device and at least one processing device coupled to the at least one non-transitory storage device. In such an embodiment, the at least one processing device is configured to carry out the method discussed herein.

Referring now to Block 2000 of FIG. 20, the method may include receive a controller run-time code for a power system structure. The controller run-time code may the various instructions and information discussed above in reference to FIG. 19. The controller run-time code may be generated using the systems discussed herein. The controller run-time code is specifically designed to operate the power system structure.

The method may include generating a configuration of the power system structure. Various configurations of power system structures may be generated using the systems and methods discussed herein, such as the method discussed in reference to FIGS. 5 and 17. Based on the power system structure system, the controller run-time code can be configured specifically to operate the power system structure. The controller run-time code may therefore be tailored to operate the specific power system structure that was generated. The controller run-time code can also be updated based on any changes to the power system structure configuration.

The controller run-time code is configured to effectively operate the power system structure based on the physical elements of the power system structure. For example, the given power system structure may have a storage device that is a battery provided by a first vendor that is different than another battery provided by a second vendor. As such, the controller run-time code must account for the specific characteristics of the individual physical elements. The operations discussed herein allow for the controller run-time code to be received by the controller (e.g., after being generated as discussed above) and implemented without any additional programming for individual physical elements. The controller run-time code may be received via a wireless network (e.g., network 150).

Referring now to Block 2010 of FIG. 20, the method may include automatically deploying the controller run-time code on the controller. The controller 120 is configured to operate a plurality of power system structures by upon receiving the controller run-time code for the given power system structure. As such, the controller 120 may have one or more underlying features that are uniform across any power system structures. The controller run-time code can then provide adjustments to the generic structure and the controller 120 can quickly and easily implement the controller run-time code.

Referring now to Block 2020 of FIG. 20, the method may include commissioning the power system structure using the deployed controller run-time code. The power system structure may be commissioned remotely using the controller 120. Since the controller run-time code is designed for the specific power system structure, the controller 120, upon automatically deploying the controller run-time code can now operate the power system structure without any additional updates.

During and/or after the power system structure is commissioned, the controller 120 may monitor the operations of the power system structure to determine whether the power system structure is operating as intended. For example, the controller 120 may confirm that the expected physical elements are connected to the power system structure before fully commissioning the power structure system and determine whether there are any unexpected physical elements in the power structure system. Any unexpected results may cause the controller 120 to cause a transmission of an alert message as discussed below in reference to Block 2050 of FIG. 20. Additionally, the controller 120 may take other actions, such as delaying or cancelling commissioning in an instance in which an unexpected result is obtained.

As discussed below in reference to Block 2040 of FIG. 20 below, the controller 120 may monitor the power system structure operations, at the physical element level and/or the entire power system structure level to identify any potential issues. The monitored variables may be compared to one or more expected values based on the controller run-time code. For example, as discussed herein, in an instance in which a power system structure schematic is generated, various expected variables, such as expected power output/input, expected nominal voltage, expected nominal current, and/or the like, may also be generated. The actual readings for the various monitored variables may be compared to the expected variables to identify any issues with the power system structure. For example, a power reading that is higher or lower than the expected power reading may indicate a difference between the digital representation of the power system structure and the physical power system structure or an issue with one or more physical elements of the power system structure (e.g., a battery may be malfunctioning and causing issues).

Referring now to optional Block 2030 of FIG. 20, the method may include receiving an update to the controller run-time code based on a change to the power system structure. Any time a physical element is replaced with a different physical element, the controller run-time code may be updated to account for the change. A user and/or system may update the power system representation with any changes to the power system structure (e.g., the element icon relating to battery A may be replaced within an element icon relating to battery B in an instance in which battery A is replaced with battery B in the power system structure). The controller 120 may automatically identify a change in the physical element (e.g., the controller 120 may determine that a replacement physical element is different than the original physical element).

The controller run-time code may be updated based on the change to the power system structure. The system (e.g., the representation generation engine 300, the entity system 200, and/or the controller 120) may determine whether a change to the physical element of the power system structure requires a change to the controller run-time code. For example, the system may compare one or more attributes of the original physical element and the replacement physical element to determine any differences in the attributes. In an instance in which the attributes do not match, the controller run-time code may be updated. The update to the controller run-time code may be received by the controller 120 and deployed as discussed above in reference to the original controller run-time code (e.g., Block 2010 of FIG. 20). The update controller run-time code may replace the original controller run-time code, such that the controller 120 installs the controller run-time code in the place of the original controller run-time code.

Referring now to optional Block 2040 of FIG. 20, the method may include monitoring one or more variables for at least one physical element of the power system structure and/or one or more variables for the power system structure. The controller 120 may monitor one or more variables for the entire power system structure (e.g., power consumption, voltage levels, current levels, operating efficiency, and/or the like). Additionally or alternatively, the controller may monitor one or more variables for individual physical element(s). For example, the controller 120 may monitor the power output of a generator.

The monitored variables may be compared to one or more expected values based on the controller run-time code. For example, as discussed herein, in an instance in which a power system structure schematic is generated, various expected variables, such as expected power output/input, expected nominal voltage, expected nominal current, and/or the like, may also be generated. The actual readings for the various monitored variables may be compared to the expected variables to identify any issues with the power system structure. For example, a power reading that is higher or lower than the expected power reading may indicate a difference between the digital representation of the power system structure and the physical power system structure or an issue with one or more physical elements of the power system structure (e.g., a battery may be malfunctioning and causing issues).

The controller 120 is configured to allow for near-real-time monitoring. The monitoring allows for any issues in the power system structure to be identified early. The controller 120 may monitor the various variables discussed above in near-real-time. For example, the controller 120 may be tracking the power consumption in real-time. The real-time or near-real-time monitored variable values may be compared to previous monitored variable values. For example, some monitored variables may remain approximately constant and a change in the monitored variable indicates a potential system failure. In another example, the monitored variable may be predictable (e.g., the power consumption of a power system structure may be higher during certain times of day or seasons) and the monitored variable may be compared to previous similar conditions.

The controller 120 is capable of performing remote testing of the power system structure. The remote test of the controller 120 may include determining one or more physical elements are operating correctly, performing initial run-time tests to confirm the system is operating as expected, safety tests, startup and/or shutdown tests, and/or the like. The configuration of the controller 120 allows for the remote testing to be completed without having to send workers to inspect the power system structure. The controller 120 may analyze and/or transmit the results of the remote tests to identify any potential issues with the power system structure.

Referring now to optional Block 2050 of FIG. 20, the method may include causing a transmission of an alert message based on a change in at least one of the one or more monitored variables of the power system structure. The alert message may indicate a potential malfunction in the power system structure. The alert message may be transmitted to one or more programmers and/or operators of the power system structure. For example, the alert message may be in the form of a notification to a supervisor of the power system structure.

In some embodiments, the controller 120 may be configured to determine one or more alert actions. The alert actions may identify the type of potential malfunction and determine one or more changes to the power system structure. For example, the controller 120 may determine that one or more physical elements is not correctly communicating within the controller 120 and therefore the said physical element needs to be updated, serviced, and/or replaced. The controller 120 may also analyze the power system structure to identify any specific issues in the power system structure (e.g., one or more physical elements is not providing the expected energy output) and determine potential changes to fix the issue.

As will be appreciated by one of skill in the art, the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present disclosure may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present disclosure may be written in an object oriented, scripted or unscripted programming language such as Java, Perl, Smalltalk, C++, or the like. However, the computer program code for carrying out operations of embodiments of the present disclosure may also be written in conventional procedural programming languages, such as the “C” programming language or similar programming languages.

Embodiments of the present disclosure are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the disclosure.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present disclosure are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the disclosure. Therefore, it is to be understood that, within the scope of the appended claims, the disclosure may be practiced other than as specifically described herein.

What is claimed is:

1. A controller for operating a power system structure, the controller comprising:
at least one non-transitory storage device; and
at least one processing device coupled to the at least one non-transitory storage device, wherein the at least one processing device is configured to:
receive a controller run-time code for a power system structure, wherein the controller run-time code is specifically designed to operate the power system structure;
automatically deploy the controller run-time code on the controller; and
commission the power system structure using the deployed controller run-time code, wherein the power system structure is commissioned remotely.

2. The controller of claim 1, wherein the at least one processing device is further configured to receive an update to the controller run-time code based on a change to the power system structure.

3. The controller of claim 1, wherein the at least one processing device is further configured to generate a configuration of the power system structure, wherein the controller run-time code is configured based on the generated configuration.

4. The controller of claim 1, wherein the at least one processing device is further configured to monitor one or more variables for at least one physical element of the power system structure.

5. The controller of claim 1, wherein the at least one processing device is further configured to monitor one or more variables of the power system structure.

6. The controller of claim 5, wherein the at least one processing device is further configured to cause a transmission of an alert message based on a change in at least one of the one or more monitored variables of the power system structure.

7. The controller of claim 1, wherein the one or more monitored variables of the power system structure comprise at least one of a power consumption or efficiency.

8. A computer program product for operating a power system structure via a controller, the computer program product comprising at least one non-transitory computer-readable medium having computer-readable program code portions embodied therein, the computer-readable program code portions comprising:
an executable portion configured to receive a controller run-time code for a power system structure, wherein the controller run-time code is specifically designed to operate the power system structure;
an executable portion configured to automatically deploy the controller run-time code on the controller; and
an executable portion configured to commission the power system structure using the deployed controller run-time code, wherein the power system structure is commissioned remotely.

9. The computer program product of claim 8, wherein the computer-readable program code portions further comprise an executable portion configured to receive an update to the controller run-time code based on a change to the power system structure.

10. The computer program product of claim 8, wherein the computer-readable program code portions further comprise an executable portion configured to generate a configuration of the power system structure, wherein the controller run-time code is configured based on the generated configuration.

11. The computer program product of claim 8, wherein the computer-readable program code portions further comprise an executable portion configured to monitor one or more variable for at least one physical element of the power system structure.

12. The computer program product of claim 8, wherein the computer-readable program code portions further comprise an executable portion configured to monitor one or more variables of the power system structure.

13. The computer program product of claim 12, wherein the computer-readable program code portions further comprise an executable portion configured to cause a transmission of an alert message based on a change in at least one of the one or more monitored variables of the power system structure.

14. The computer program product of claim 8, wherein the one or more monitored variables of the power system structure comprise at least one of a power consumption or efficiency.

15. A computer-implemented method for operating a power system structure via a controller, the method comprising:
receiving a controller run-time code for a power system structure, wherein the controller run-time code is specifically designed to operate the power system structure;
automatically deploying the controller run-time code on the controller; and
commissioning the power system structure using the deployed controller run-time code, wherein the power system structure is commissioned remotely.

16. The method of claim 15, further comprising receiving an update to the controller run-time code based on a change to the power system structure.

17. The method of claim 15, further comprising monitoring one or more variables for at least one physical element of the power system structure.

18. The method of claim 15, further comprising generating a configuration of the power system structure, wherein the controller run-time code is configured based on the generated configuration.

19. The method of claim 18, further comprising causing a transmission of an alert message based on a change in at least one of the one or more monitored variables of the power system structure.

20. The method of claim 15, wherein the one or more monitored variables of the power system structure comprise at least one of a power consumption or efficiency.
